(19) United States
(12) Patent Application Publication
(10) Pub. No.: US 2006/0164856 A1
(43) Pub. Date: Jul. 27, 2006

(54) Inflatable doll luminous ornament

(76) Inventor: Min-Hsien Wang, Taipei City (TW)

Correspondence Address: Min-Hsien Wang, P. O. Box No. 6-57, Junghe, Taipei 235, TW

(21) Appl. No.: 11/038,197

(22) Filed: Jan. 21, 2005

(51) Int. Cl. G02B 6/04; F21V 7/04

(52) U.S. Cl. 362/554; 362/806

(57) ABSTRACT

The present invention relates to an inflatable doll luminous ornament and more particularly for an air chamber inflated with air to form a blown-up doll, which includes a ballast on the bottom, a coating on an outer surface, and ornaments of optical fibers on the coating, wherein one end of each optical fiber being bound together connecting to a diode and further to a hidden light source, light passing through optical fibers to generate flares at ends and also create a halo effect along the radial direction.

### BACKGROUND OF THE INVENTION

(a) Field of the Invention

The present invention relates to an inflatable doll luminous ornament and more particularly for a doll having optical fiber ornaments and being able to be deflated for storage and inflated to form a blown-up doll.

(b) Description of the Prior Art

A conventional doll is formed with elements such as a head, hands, and a torso assembling together and covering with a colorful coating or cloth to simulate human being appearance and dressing. Defects can be
1. each element is of a fixed volume, which is not cost effective for keeping a large volume for shipping;
2. using external light sources is the only solution to illuminate the colorful surface, which losses visibility and affinity to children after removing light sources;

### SUMMARY OF THE INVENTION

The present invention is a doll being able to be inflated through an air inlet to form a blown-up doll and deflated to minimum the volume for storage or transportation, wherein the blown-up doll having a coating with optical fiber ornaments to enhance visual beauty. The present invention can be used as an illumination at dark and may also equip with a sound device to generate sound effects when illuminating.

The luminous ornaments can be formed anywhere needed by laying optical fibers in or on the coating, with one end of each optical fiber being bound together to connect to a diode and further to a light source and the other end thereof forming an optical fiber belt adhering on the coating or forming a hank of optical fibers either decorating on the coating or penetrating through the coating from inside to form multi-point flares, wherein the light source being formed outside or inside the coating and the hank of optical fibers being fixed between the air chamber and the coating.

To enable a further understanding of the said objectives and the technological methods of the invention herein, the brief description of the drawings below is followed by the detailed description of the preferred embodiments.

### BRIEF DESCRIPTION OF THE DRAWING

FIG. 1 shows a perspective view of the present invention.

FIG. 2 shows an exploded elevational view from the rear of FIG. 1.

FIG. 3 shows a schematic view of luminous elements of the present invention.

FIG. 4 shows a perspective view of a light source arrangement of the present invention.

FIG. 5 shows a perspective view of how optical fibers being fixed of the present invention.

FIG. 6 shows another exploded elevational view of the arrangement of luminous ornaments of the present invention.

FIG. 7 shows a schematic view of how an optical fiber ice curtain being formed of the present invention.

FIG. 8 shows a perspective view of FIG. 6 after assembling.

### DETAILED DESCRIPTION OF THE PREFERRED EMBODIMENTS

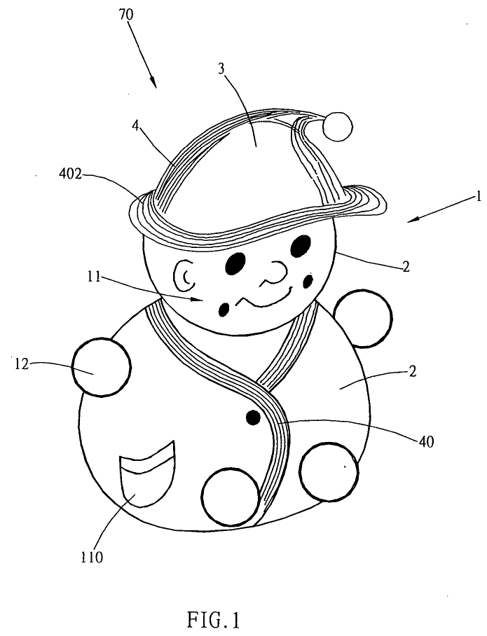

Referring to FIGS. 1. The present invention relates to a luminous ornament arrangement on an inflatable doll 1 having ornaments 70, a coating 2, limbs 12, and a decorative pocket 110, wherein, ornaments 70 such as a headgear 3 formed by optical fibers 4 with an optical fiber ribbon 402 on the outer perimeter, the coating 2 having an optical fiber belt 40 around the collar, and the decorative pocket 110 outlined by optical fibers 4.

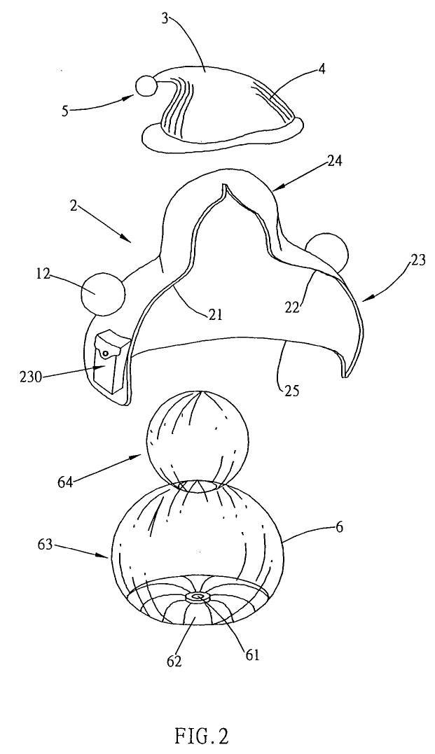

Referring to FIG. 2. The doll 1 is formed by an air chamber 6 covered with the coating 2 and the headgear 3, wherein
the air chamber 6 having of a head 64 connecting unobstructedly to a torso 63 with an air inlet 61 on the bottom for filling air therein to prop up the blown-up doll 1 and with a ballast 62, being sand, water, etc, keeping the doll 1 in upright position;
the coating 2, being a kind of cloth, leather, fabric, or other elastic material and having a pre-decorated pattern, including a body enclosure 23, a head enclosure 24, and a bottom enclosure 25 to enclose the air chamber 6 when having plackets 21 and 22 zippered, buttoned, snap fastened, or tape fastened, wherein a pocket 230 formed to accommodate a light source 5 and limbs 12 formed to simulate human being's arms and legs;
the headgear 3, formed by optical fibers 4 with an independent light source 5, enabling the headgear 3 being exchangeable for being worn on different dolls' head.

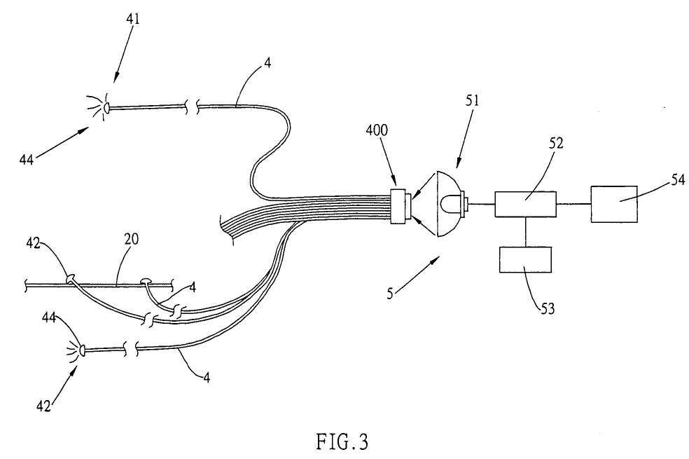

Referring to FIG. 3. The luminous ornament is formed by a light beam generating from the light source 5 passing through a diode 400, optical fibers 4, and to emitting ends 41 where flares 44 generate, wherein the light source 5, including an illuminator 51, an electrical controlling circuit 52, and an operation terminal 53, supplying optical fibers 4 with light of various wave lengths through operating the operation terminal 53. The electrical controlling circuit 52 can also be designed to control a sound device 54 such that songs or music can be played simultaneously with flares 44 acting to increase amusement effect. Furthermore, each terminal of optical fibers 4 can be a light diffusion head 42 like a mushroom which not only diffusing flares 44 but also playing a button role through buttoning on the cloth 20 from inside, while the rest part of optical fibers 4 being hidden and fixed between the air chamber 6 and the cloth 20.

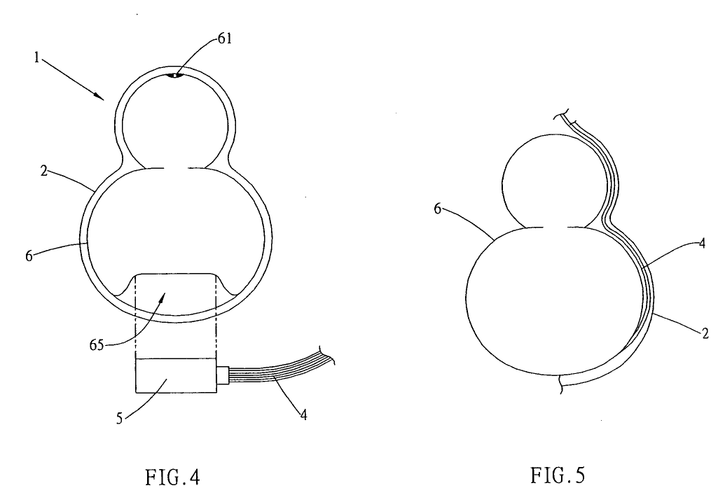

Referring to FIG. 4. Besides being fitted in a pocket 230, the light source 5 can be fixed on the bottom of the air chamber 6 to form the ballast 62 for keeping the doll 1 always in upright position, wherein a concaved part 65 formed to accommodate the light source 5 being fixed by forces from the blown-up air chamber 6 and the coating 2 with plackets 21 and 22 connected.

Referring to FIGS. 1 and 5. Optical fibers 4 may be either being fixed between the blow-up air chamber 6 and the coating 2 or forming the optical fiber belt 40 adhering to the coating 2 or forming the optical fiber ribbon 402 surrounding the outer perimeter of headgear 3, wherein the optical fiber ribbon 402 being fixed in any feasible way.

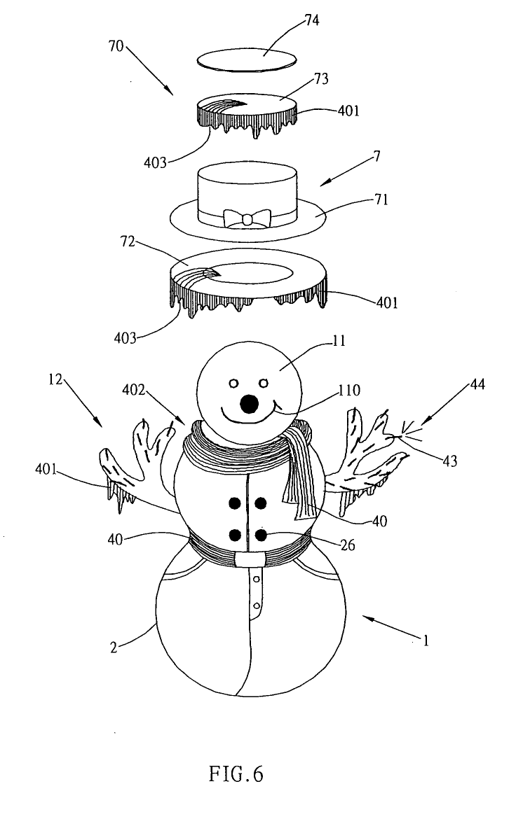

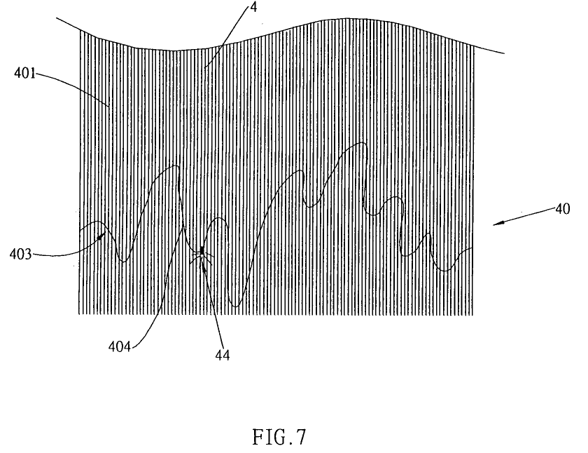

The doll 1 can be a form like that shown in FIG. 6 having the coating 2, the optical fiber belt 40 around the waist, a scarf around the neck formed by the optical fiber ribbon 402 with the optical fiber belt 40 at each end, limbs 12 decorated with flares 44 at ends 43 of optical fibers 4, optical fiber ice curtains 401 formed under each limb 12, a ring 72, and a circular disk 73, wherein the optical fiber belt 40 and the optical fiber ribbon 402 connecting in any way with the light source 5; the light source 5, preferably being hidden, connecting in any feasible way to optical fiber ice curtains 401 or optical fiber belts 40; the ring 72 being designed to attach to a brim 71 of a boater 7; and the circular disk 73 being assembled to a top 74 of the boater 7 with ornaments 70.

Referring to FIG. 7. The optical fiber ice curtain 401 is formed by an optical fiber belt 40, being formed by assembling optical fibers 4, with a tailored edge 403 similar to an ice curtain and with flares 44 at each end thereof to form the edge 403, thereby forming a high contrast luminous curve of the optical fiber ice curtain 401. As optical fibers are formed by ornamental plastic optical fibers, the lateral can be a little dim, causing a halo effect in the length direction of the optical fiber ice curtain 401, which can be friendlier to the human's eyes.

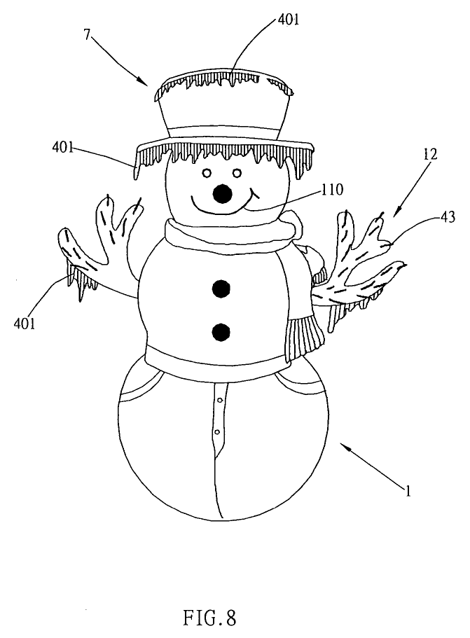

Referring to FIG. 8. The doll 1 decorated with the boater 7 and limbs 12. When simulating snow covering condition, the optical fiber ice curtain 401 can be formed under limbs 12, under the brim 71, and under the top of the boater 7. Optical fibers can also be used to outline a mouth 110, a nose, and eyes etc and illuminating thereof.

It is of course to be understood that the embodiment described herein is merely illustrative of the principles of the invention and that a wide variety of modifications thereto may be effected by persons skilled in the art without departing from the spirit and scope of the invention as set forth in the following claims.

What is claimed is:

1. An inflatable doll luminous ornament and more particularly for an air chamber inflated with air to form a blown-up doll comprising a ballast on the bottom, a coating on an outer surface, and optical fiber ornaments on the coating, wherein one end of each optical fiber being bound together connecting to a diode and further to a hidden light source.

2. The inflatable doll luminous ornament as recited in claim 1, wherein the light source being formed in a pocket.

3. The inflatable doll luminous ornament as recited in claim 1, wherein the light source being formed on the bottom as a ballast.

4. The inflatable doll luminous ornament as recited in claim 1, wherein optical fibers being fixed between the blown-up air chamber and the coating.

5. The inflatable doll luminous ornament as recited in claim 1, wherein terminals of optical fibers being mushroom-like light diffusion heads.

6. The inflatable doll luminous ornament as recited in claim 1, wherein flares at each end of optical fibers exposing outside the coating.

7. The inflatable doll luminous ornament as recited in claim 1, wherein an optical fiber belt being assembled from optical fibers and covered on the coating.

8. The inflatable doll luminous ornament as recited in claim 1, wherein the coating being an elastic material.

9. The inflatable doll luminous ornament as recited in claim 1, wherein the coating having additional ornaments.

10. The inflatable doll luminous ornament as recited in claim 9, wherein ornaments having an independent source.

11. The inflatable doll luminous ornament as recited in claim 9, wherein ornaments being an optical fiber ice curtain formed by an optical fiber belt connecting with a light source.

12. The inflatable doll luminous ornament as recited in claim 11, wherein the optical fiber belt being tailored to form an ice curtain edge.
